(19) United States
(12) Patent Application Publication
(10) Pub. No.: US 2008/0055612 A1
(43) Pub. Date: Mar. 6, 2008

(54) PRINTER AND CONTROL METHOD THEREFOR

(75) Inventor: Kouji Miura, Shizuoka (JP)

Correspondence Address: PEARNE & GORDON LLP, 1801 EAST 9TH STREET, SUITE 1200, CLEVELAND, OH, 44114-3108, US

(73) Assignee: STAR MICRONICS CO., LTD., Shizuoka (JP)

(21) Appl. No.: 11/847,513

(22) Filed: Aug. 30, 2007

(30) Foreign Application Priority Data
Aug. 31, 2006 (JP) 2006-234982

(51) Int. Cl. G06F 3/12

(52) U.S. Cl. 358/1.1

(57) ABSTRACT

A printer includes: a carriage mounting a print head; a stepping motor for causing the carriage to reciprocate with respect to a recording medium; a print timing correction information storage unit for storing print timing correction information indicating a degree of correction of print timing; an additional step count acquisition unit for acquiring a step count of the stepping motor corresponding to the degree of correction of print timing indicated by the print timing correction information as an additional step count; and a carriage reciprocation control unit for controlling a step count of the stepping motor related to reciprocation of the carriage based on a step count of the stepping motor corresponding to a print timing count set to a going path and a returning path and the additional step count acquired by the additional step count acquisition unit.

### CROSS REFERENCE TO RELATED APPLICATION

This application claims priority from a Japanese Patent Application No. 2006-234982 filed on Aug. 31, 2006, the entire subject matter of which is incorporated herein by reference.

### TECHNICAL FIELD

The present invention relates to a printer and a control method therefor.

### BACKGROUND

A printer is known comprising a carriage on which a print head is mounted and a stepping motor (carriage motor) for causing the carriage to reciprocate with respect to the recording medium, the printer performing printout on a recording medium on a going path and a returning path. On such a printer, a print position on the going path may be dislocated from that on the returning path in the reciprocating direction of the carriage due to variations in the characteristics of the carriage motor, ambient temperature or secular change. This phenomenon is called “misalignment”.

Misalignment correction is made on the above printer. TO be more specific, the reciprocating travel range of a carriage is set to a maximum range where the carriage can travel within the limit of the printer mechanism and the print timing on the going path and returning path is corrected depending on the degree of misalignment thus preventing misalignment.

Misalignment correction on a related art printer will be described referring to FIGS. 15 to 17. FIGS. 15 to 17 show driving control of a carriage motor and a print head made while the carriage is reciprocating. In FIGS. 15 to 17, a horizontal axis represents a time axis. Each of the vertical line segments crossing the time axis shows a timing (drive timing) a driving pulse is supplied to the carriage motor. Thus, FIGS. 15 to 17 show that the driving pulse is supplied to the carriage motor 36 times in order for the carriage to travel on the going path or on the returning path.

In FIGS. 15 to 17, an acceleration section is a section where the carriage is accelerated. A constant speed section is a section where the carriage travels at a constant speed. A deceleration section is a section where the carriage is decelerated. A carriage is accelerated from a state where it stands still at one end of a reciprocating range until a predetermined speed is reached in the acceleration section, travels at a constant speed in the constant speed section, and is decelerated in the deceleration section, and stops at the other end. The carriage is then accelerated from a state where it stands still at the other end until a predetermined speed is reached in the acceleration section, travels at a constant speed in the constant speed section, and is decelerated in the deceleration section, and stops at the one end. In this way, the carriage repeats reciprocation. In the acceleration section, the drive timing interval of the carriage motor gradually decreases, for example from 800 μs (microseconds) to 420 μs. In the constant speed section, the drive timing interval of the carriage motor is fixed to 417 μs, for example. In the deceleration section, the drive timing interval of the carriage motor gradually increases, for example from 420 μs to 800 μs.

In FIGS. 15 to 17, solid triangles indicate the drive timings (print timings) of the print head. Thus, FIGS. 15 to 17 show that nine print timings are set on each of the going path and returning path. Printout on a recording medium is generally made in a constant speed section. The print timing interval is set so that it will be equal to the drive timing interval of a carriage motor in a constant speed section and that two or more print timings will not take place within a single drive timing interval of a carriage motor. A drive timing interval of a carriage motor is herein called a “timer”. For example, as shown in FIGS. 15 to 17, in case the number of the drive timing intervals of a carriage motor in a constant speed section is 21, description herein is “the number of timers in a constant speed section is 21.”

Among FIGS. 15 to 17, FIG. 15 shows a case where misalignment correction hardly takes place. That is, FIG. 15 shows a case where print timings are hardly corrected. FIG. 16 shows a case where the print timings are advanced for misalignment correction. FIG. 17 shows a case where the print timings are delayed for misalignment correction. In this way, on a related art printer, the reciprocating range of a carriage is set to a maximum range where the carriage can travel within the limit of the printer mechanism, or in other words, the constant speed section of a carriage is set to a maximum value supported by the printer mechanism, and misalignment correction is performed by advancing/delaying the print timing with respect to the preset value depending on the degree of misalignment.

### SUMMARY

In case misalignment correction is made as mentioned above, the number of sections increases where a carriage travels without printing being performed (called “free traveling section”). For example, as shown in FIGS. 15 to 17, a section from the start timing of the constant speed section to the first print timing (hereinafter referred to as the “early free traveling section”) and a section from the last print timing to the end timing of the constant speed section (hereinafter referred to as the “late free traveling section”) are free traveling sections. Increasing number of free traveling sections requires more time for printing thus lowering the throughput (print speed).

The invention has been accomplished in view of the above problems. An object of the invention is to provide a printer capable of performing misalignment correction while enhancing the throughput and a control method therefor.

In order to solve the problems, the invention provides a printer, which performs printout on a recording medium on a going path and a returning path, including: a carriage mounting a print head; a stepping motor for causing the carriage to reciprocate with respect to the recording medium; a print timing correction information storage unit for storing print timing correction information indicating a degree of correction of print timing; an additional step count acquisition unit for acquiring a step count of the stepping motor corresponding to the degree of correction of print timing indicated by the print timing correction information as an additional step count; and a carriage reciprocation control unit for controlling a step count of the stepping motor related to reciprocation of the carriage based on a step count of the stepping motor corresponding to a print timing count set to the going path or the returning path and the additional step count acquired by the additional step count acquisition unit.

The invention provides a printer control method for controlling a printer including a carriage mounting a print head, a stepping motor for causing the carriage to reciprocate with respect to a recording medium and a print timing correction information storage unit for storing print timing correction information indicating a degree of correction of print timing, the printer performing printout on the recording medium on a going path and a returning path, the method including: reading the print timing correction information indicating the degree of correction of print timing from the print timing correction information storage unit; acquiring a step count of the stepping motor corresponding to the degree of correction of print timing indicated by the print timing correction information as an additional step count; and controlling a step count of the stepping motor related to reciprocation of the carriage based on a step count of the stepping motor corresponding to a print timing count set to the going path or the returning path and the additional step count.

The invention relates to a printer including a carriage mounting a print head and a stepping motor for causing the carriage to reciprocate with respect to a recording medium, the printer performing printout on the recording medium on a going path and a returning path. According to the invention, print timing correction information indicating a degree of correction of print timing is stored. A step count of the stepping motor corresponding to the degree of correction of print timing indicated by the print timing correction information is acquired as an additional step count. Further, A step count of the stepping motor related to reciprocation of the carriage is controlled based on a step count of the stepping motor corresponding to a print timing count set to the going path and the returning path and the additional step count. According to the invention, it is possible to perform misalignment correction while enhancing the throughput.

According to another aspect of the invention, the going path and the returning path each includes an acceleration section where the carriage is accelerated, a constant speed section where the carriage travels at a constant speed and a deceleration section where the carriage is decelerated. Further, printout on the recording medium is made in the constant speed section. Further, the carriage reciprocation control unit may control a step count of the stepping motor related to the constant speed section based on a step count of the stepping motor corresponding to a print timing count set to the constant speed section and the additional step count acquired by the additional step count acquisition unit.

According to another aspect of the invention, the additional step count acquisition unit includes an additional step count information storage unit for storing additional step count information associating the degree of correction of the print timing and the additional step count, and the additional step count acquisition unit may acquire the additional step count corresponding to the degree of correction of print timing indicated by the print timing correction information based on the additional step count information.

### BRIEF DESCRIPTION OF THE DRAWINGS

In the accompanying drawings:

FIG. 1 shows a general configuration of a printer according to one aspect of the invention;

FIG. 2 illustrates an exemplary print control made in case the misalignment correction level is 24 to 27;

FIG. 3 illustrates an exemplary print control made in case the misalignment correction level is 16 to 23;

FIG. 4 illustrates an exemplary print control made in case the misalignment correction level is 8 to 15;

FIG. 5 illustrates an exemplary print control made in case the misalignment correction level is 0 to 7;

FIG. 6 illustrates an exemplary print control made in case the misalignment correction level is 28 to 35;

FIG. 7 shows an exemplary print control made in case the misalignment correction level is 36 to 43;

FIG. 8 shows an exemplary print control made in case the misalignment correction level is 44 to 51;

FIG. 9 illustrates a misalignment correction level;

FIG. 10 illustrates an example of correction level stored in a storage;

FIG. 11 is a flowchart of the processing executed by the printer;

FIG. 12 illustrates the processing executed by the printer;

FIGS. 13A and 13B illustrate the print control using the number of additional timers Nb;

FIG. 14 is a functional block diagram of a printer according to one aspect of the invention the invention;

FIG. 15 illustrates a related art print control;

FIG. 16 illustrates the related art print control; and

FIG. 17 illustrates the related art print control.

### DETAILED DESCRIPTION

An embodiment of the invention will be detailed referring to drawings.

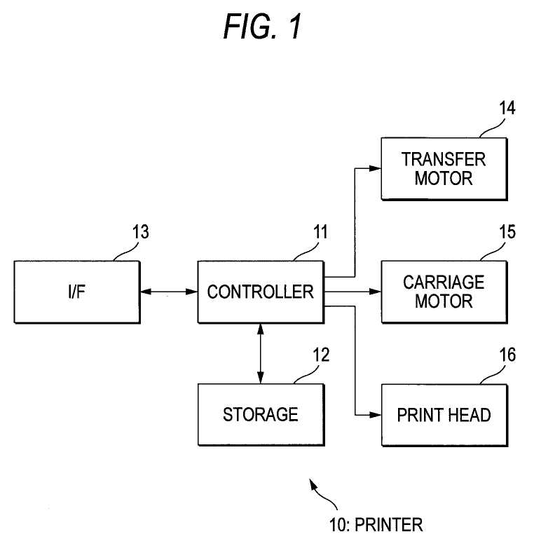

FIG. 1 shows a general configuration of a printer according to an embodiment of the invention. As shown in FIG. 1, a printer 10 according to this embodiment comprises a controller 11, a storage 12, an interface (I/F) 13, a transfer motor 14, a carriage motor 15, and a print head 16.

The controller 11 operates in accordance with a program stored in the storage 12 to control the entire printer 10. The storage 12 includes a computer-readable information storage medium such as a ROM (Read Only Memory) or a RAM (Random Access Memory). The storage 12 operates also as a work memory for storing various data for executing various processing. The interface 13 is used to establish communications with a host computer (not shown) in order to communicate data with the same. The interface 13 receives print data such as a document and an image from the host computer and supplies the data to the controller 11.

The transfer motor 14 is a stepping motor for transferring a recording medium such as paper in a predetermined direction. The carriage motor 15 is a stepping motor for causing the carriage mounting a print head 16 to reciprocate in a direction orthogonal to the transfer direction of a recording medium. The step count (rotation angle) of the carriage motor 15 uniquely corresponds to the position of the carriage. By controlling the step count and driving interval of the carriage motor 15, position and travel speed of the carriage are controlled. The print head is mounted on the carriage and print on the recording medium. The printer 10 causes the print head 16 to reciprocate with respect to the recording medium while driving the print head 16 on the going path and returning path based on print data to print characters or images corresponding to the print data on the recording medium.

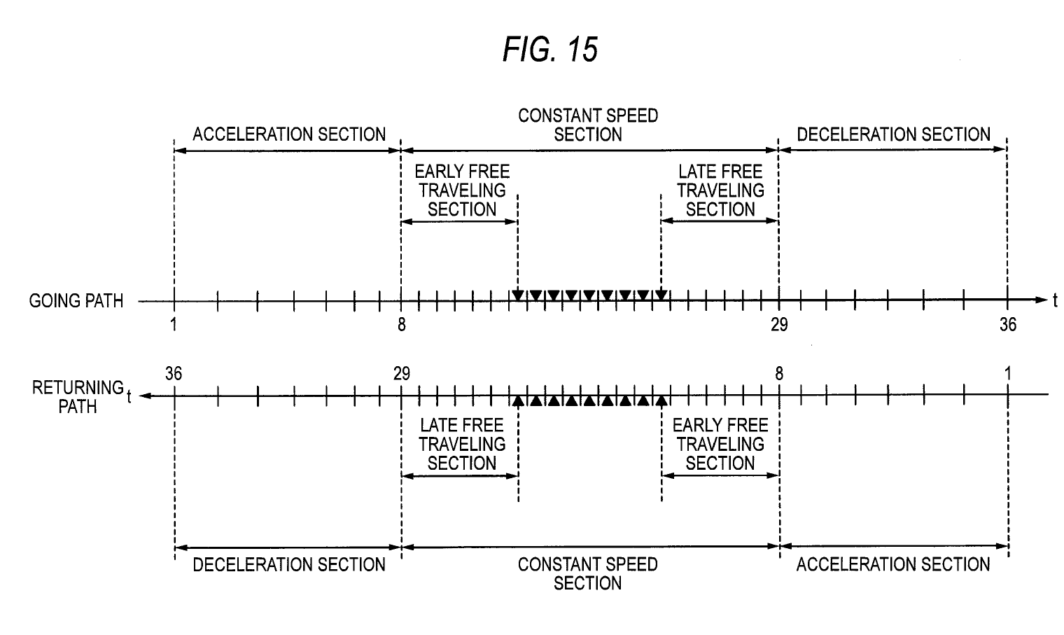

With the printer 10 also, same as the example shown in FIGS. 15 to 17, the carriage is accelerated from a state where it stands still at one end until a predetermined speed is reached in the acceleration section, travels at a constant speed in the constant speed section, and is decelerated in the deceleration section, and stops at the other end. The carriage is then accelerated from a state where it stands still at the other end until a predetermined speed is reached in the acceleration section, travels at a constant speed in the constant speed section, and is decelerated in the deceleration section, and stops at the one end. In this way, the carriage repeats reciprocation. In the acceleration section, the drive timing interval of the carriage motor gradually decreases, for example from 800 μs to 420 μs. In the constant speed section, the drive timing interval of the carriage motor is fixed to 417 μs. In the deceleration section, the drive timing interval of the carriage motor gradually increases, for example from 420 μs to 800 μs. Printout on a recording medium is made in the constant speed section. The print timing interval is equal to the drive timing interval of a carriage motor in a constant speed section (417 μs) and two or more print timings do not take place within a single drive timing interval of a carriage motor.

With the printer 10 according to this embodiment, the number of timers in a constant speed section changes with the degree of misalignment correction so as to minimize the free traveling section in a constant speed section. As a result, the reciprocation distance of a carriage is reduced and misalignment correction is provided with the throughput being enhanced in the printer 10.

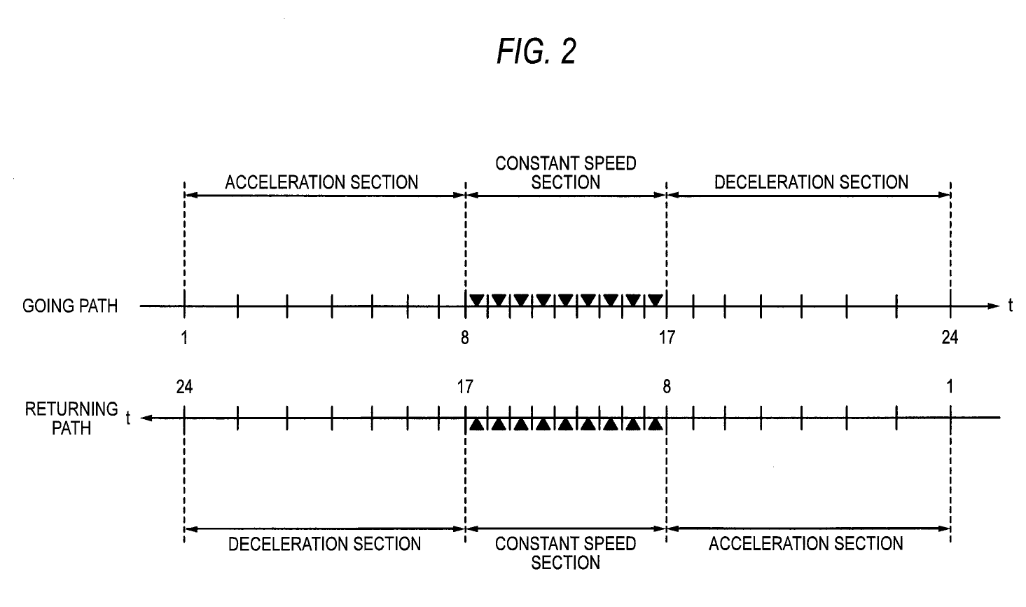

The misalignment correction feature available on the printer 10 will be described first. FIGS. 2 to 8 illustrate the misalignment correction feature on the printer 10. FIGS. 2 to 8 show driving control of a carriage motor and a print head made while the carriage is reciprocating such as FIGS. 15 to 17. In each drawing of the invention, a horizontal axis represents a time axis, and each of the vertical line segments crossing the time axis shows a timing (drive timing) a driving pulse is supplied to the carriage motor. And also solid triangles indicate the drive timings (print timings) of the print head.

FIG. 2 shows a case where misalignment correction (print timing correction) hardly takes place. As shown in FIG. 2, timers are not added at both ends of a constant speed section and the number of timers in a constant speed section is equal to the number of print timings. In other words, the number of timers in a constant speed section is the smallest in this case.

In the case of FIG. 2, the degree of misalignment correction is the same as that in FIG. 15. As understood from the comparison between FIG. 2 and FIG. 15, an early free traveling section and a late free traveling section are almost negligible in this embodiment (FIG. 2). That is, time required for reciprocation of a carriage in this embodiment is shorter than that in FIG. 15, meaning that the throughput (print speed) is enhanced.

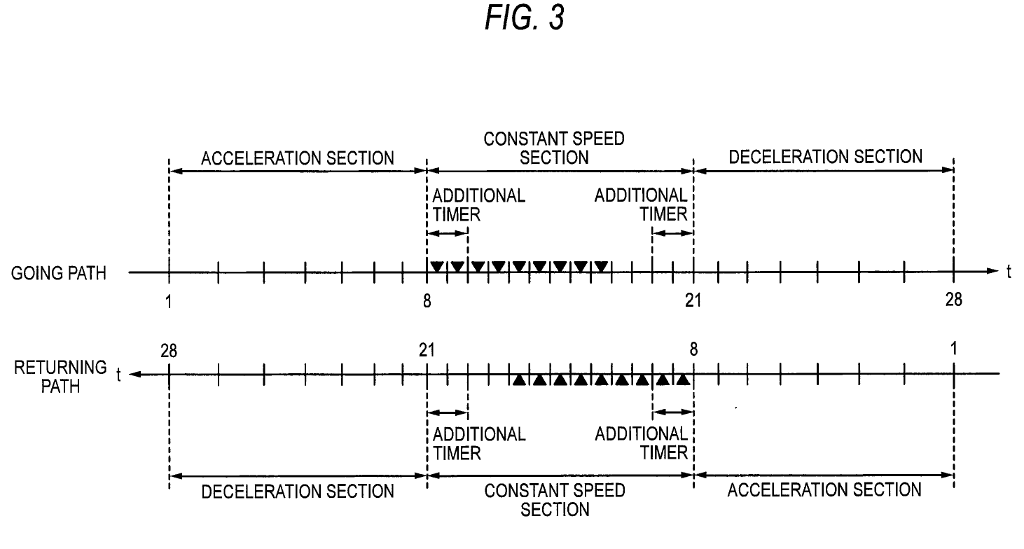

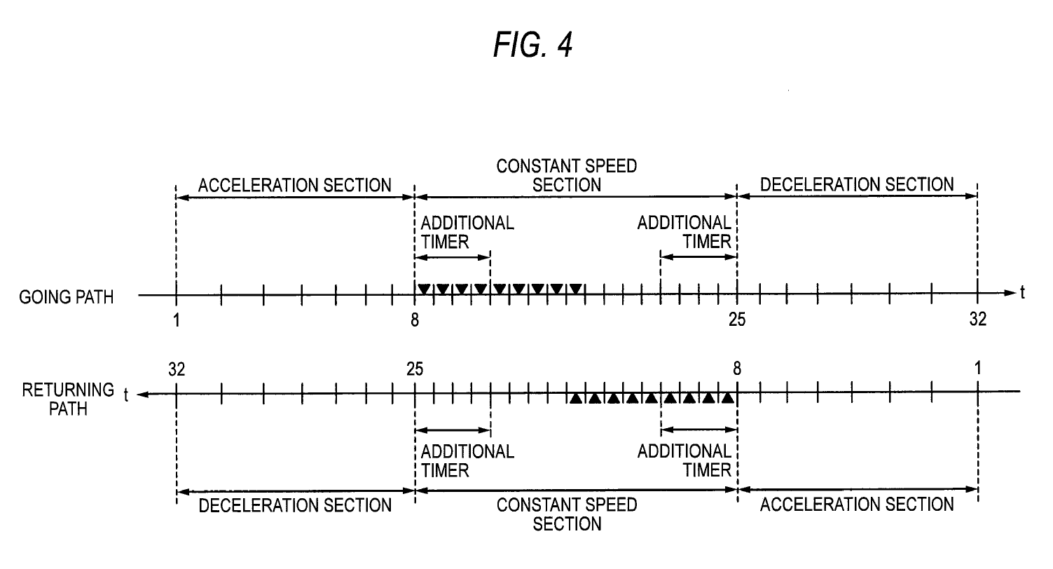

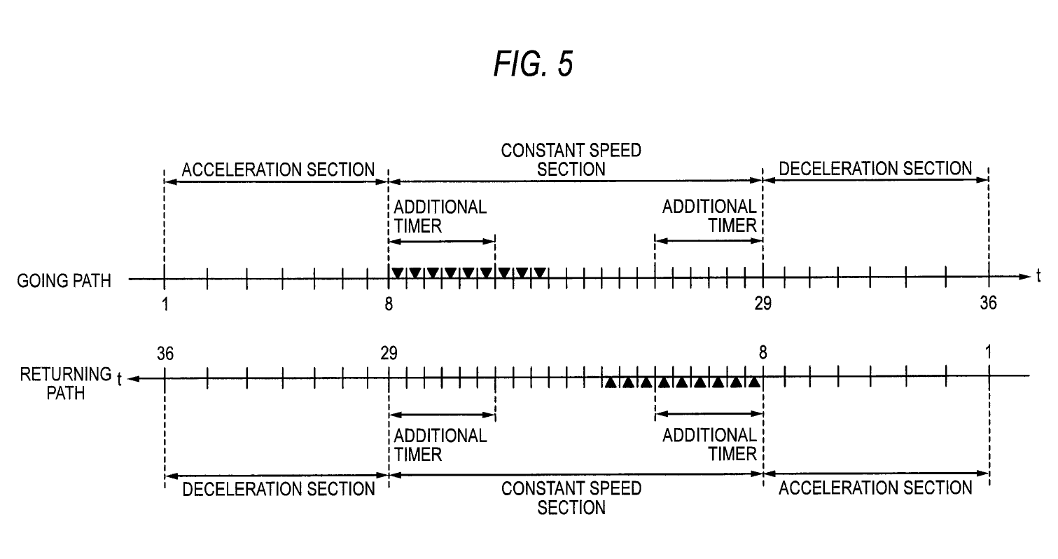

FIGS. 3 through 5 show a case where misalignment correction is made by advancing the print timing. Among FIGS. 3 to 5, FIG. 3 shows a case where the degree of misalignment correction (degree of advancing the print timing) is the smallest. FIG. 4 shows a case where the degree of misalignment correction is greater than that shown in FIG. 3. FIG. 5 shows a case where the degree of misalignment correction is still greater than that shown in FIG. 4. In the case of FIG. 3, two timers are added at each of the end of a constant speed section so that the number of timers in a constant speed section is 13. In the case of FIG. 4, four timers are added at each of the end of a constant speed section so that the number of timers in a constant speed section is 17. In the case of FIG. 5, six timers are added at each of the end of a constant speed section so that the number of timers in a constant speed section is 21. In this embodiment, the number of timers respectively added at both ends of a constant speed section changes within a range of 0 to 6 depending on the degree of misalignment correction in case misalignment correction is performed by advancing the print timing.

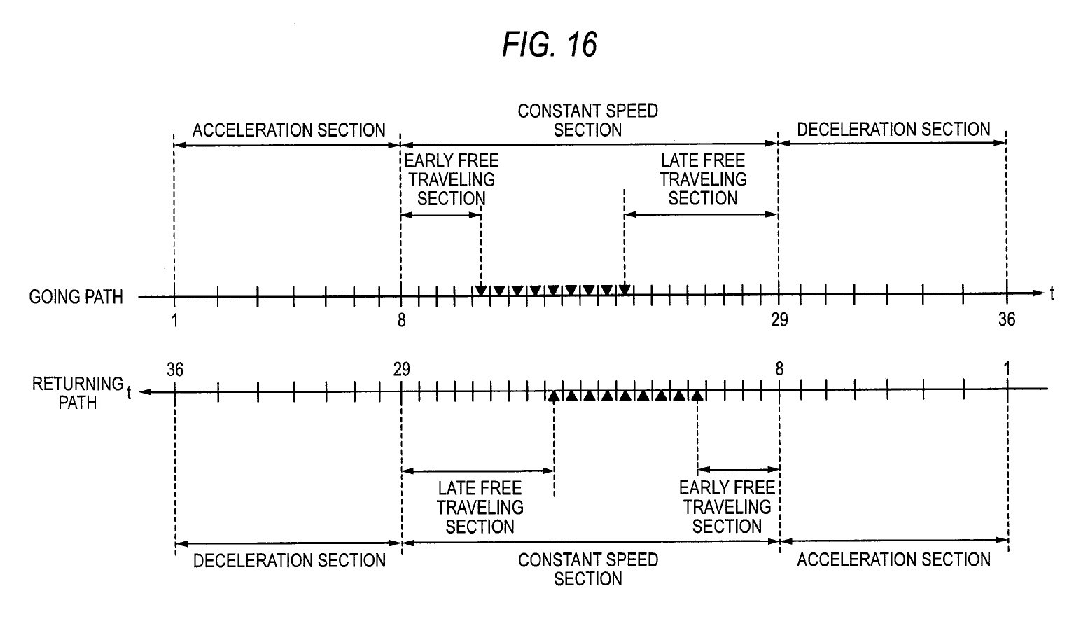

FIG. 3 shows a case where the degree of misalignment correction (degree of advancing the print timing) is the same as that in the case shown in FIG. 16. As understood from the comparison between FIG. 3 and FIG. 16, the early free traveling section on the going path that is shorter than the late free traveling section is almost negligible and the later free traveling section is shortened by the length the early free traveling section shrinks in this embodiment (FIG. 3). In this embodiment, time required for reciprocation of a carriage is shorter than that in FIG. 16, meaning that the throughput (print speed) is enhanced.

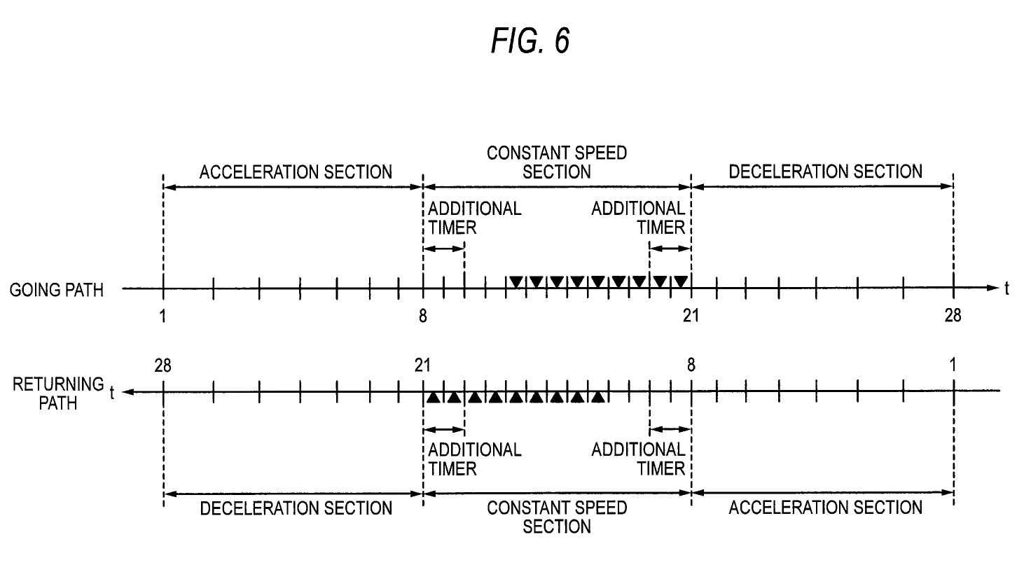

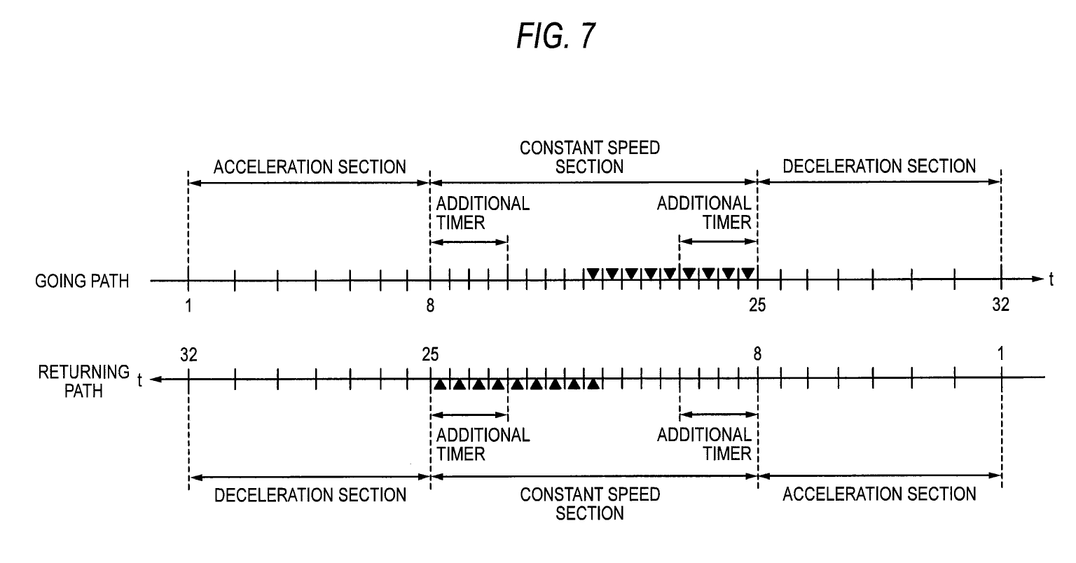

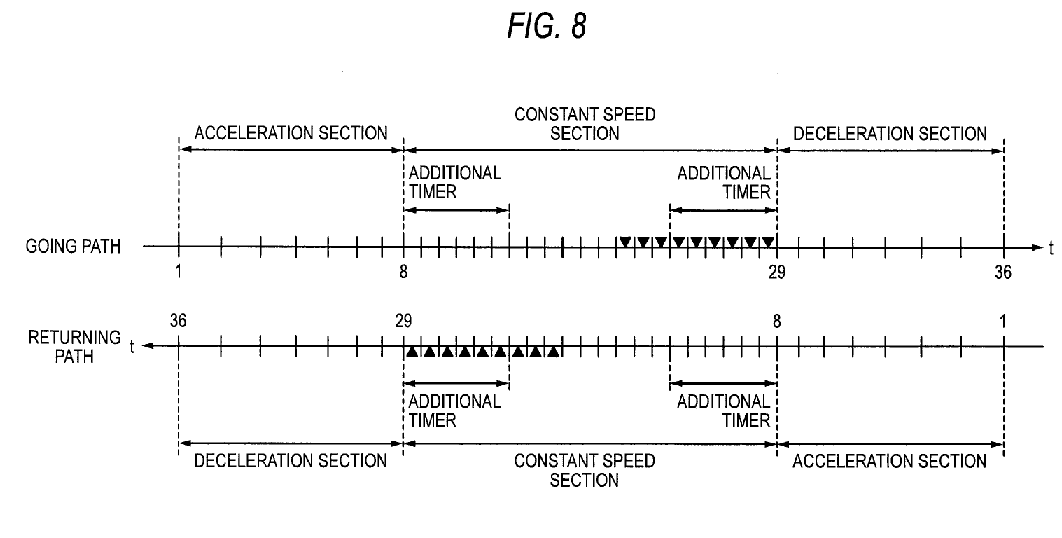

FIGS. 6 through 8 show a case where misalignment correction is made by delaying the print timing. Among FIGS. 6 to 8, FIG. 6 shows a case where the degree of misalignment correction (degree of delaying the print timing) is the smallest. FIG. 7 shows a case where the degree of misalignment correction is greater than that shown in FIG. 6. FIG. 8 shows a case where the degree of misalignment correction is still greater than that shown in FIG. 7. In the case of FIG. 6, two timers are added at each of the end of a constant speed section so that the number of timers in a constant speed section is 13. In the case of FIG. 7, four timers are added at each of the end of a constant speed section so that the number of timers in a constant speed section is 17. In the case of FIG. 8, six timers are added at each of the end of a constant speed section so that the number of timers in a constant speed section is 21. In this embodiment, the number of timers respectively added at both ends of a constant speed section changes within a range of 0 to 6 depending on the degree of misalignment correction also in case misalignment correction is performed by delaying the print timing.

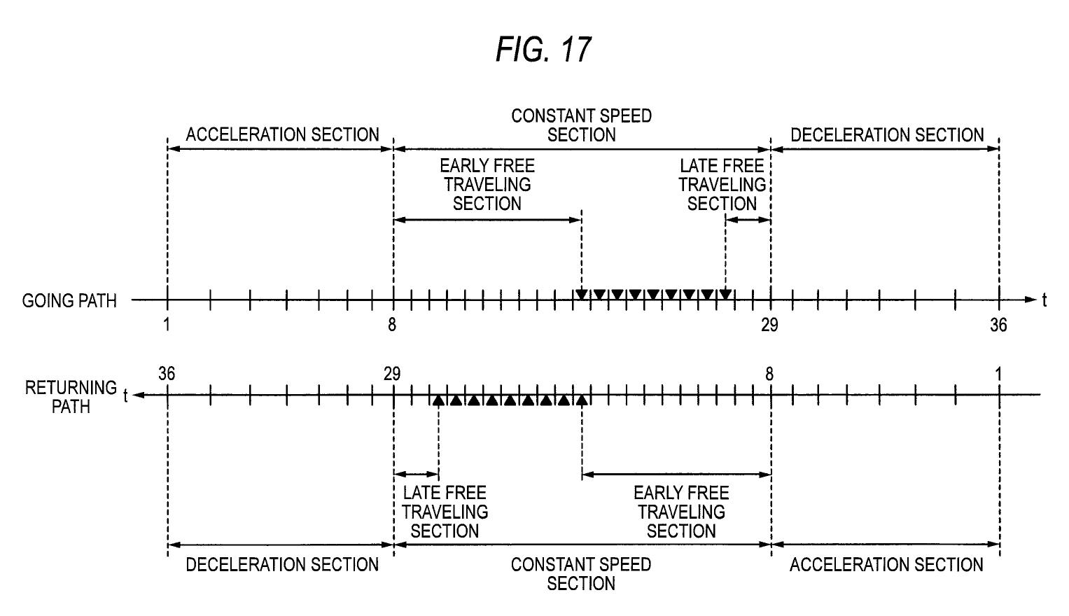

FIG. 7 shows a case where the degree of misalignment correction (degree of delaying the print timing) is the same as that in the case shown in FIG. 17. As understood from the comparison between FIG. 7 and FIG. 17, the late free traveling section on the going path that is shorter than the early free traveling section is almost negligible and the early free traveling section is shortened by the length the late free traveling section shrinks in this embodiment (FIG. 7). In this embodiment, time required for reciprocation of a carriage is shorter than that in FIG. 17, meaning that the throughput (print speed) is enhanced.

With the printer 10, the number of timers respectively added at both ends of a constant speed section changes within a range of 0 to 6 depending on the degree of misalignment correction so that a free traveling section in a constant speed section will be minimized. As a result, the printer 10 provides a reduced reciprocation distance of a carriage and performs misalignment correction while enhancing the throughput.

Next, a configuration for providing the misalignment correction feature will be described.

Data stored in the storage 12 will be described. The storage 12 stores a misalignment correction level that indicates the degree of misalignment correction (degree of correction of print timing).

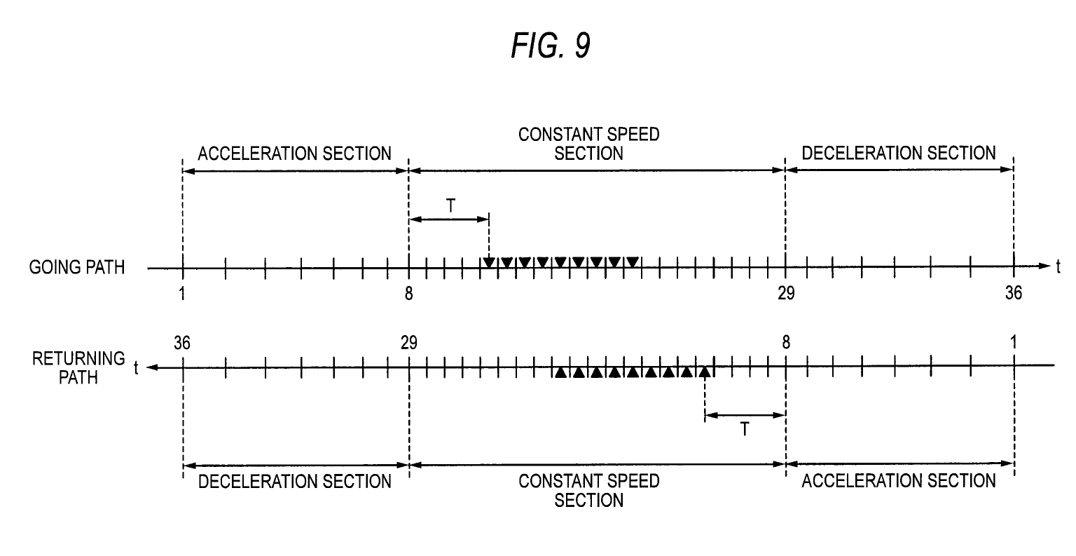

FIG. 9 illustrates a misalignment correction level. This embodiment indicates the degree of misalignment correction by the time T from the start timing of a constant speed section to the first print timing in a case where the number of timers in a constant speed section is the largest, that is, a case where six timers are respectively added at both ends of a constant speed section. To be more specific, the misalignment correction level is information that indicates the time T in units of 105 μs. The unit time is set so that the time obtained by multiplying the unit time by an integer is below the drive timing interval of a carriage motor 15 (417 μs in this embodiment) and almost equal to the drive timing interval of the carriage motor 15.

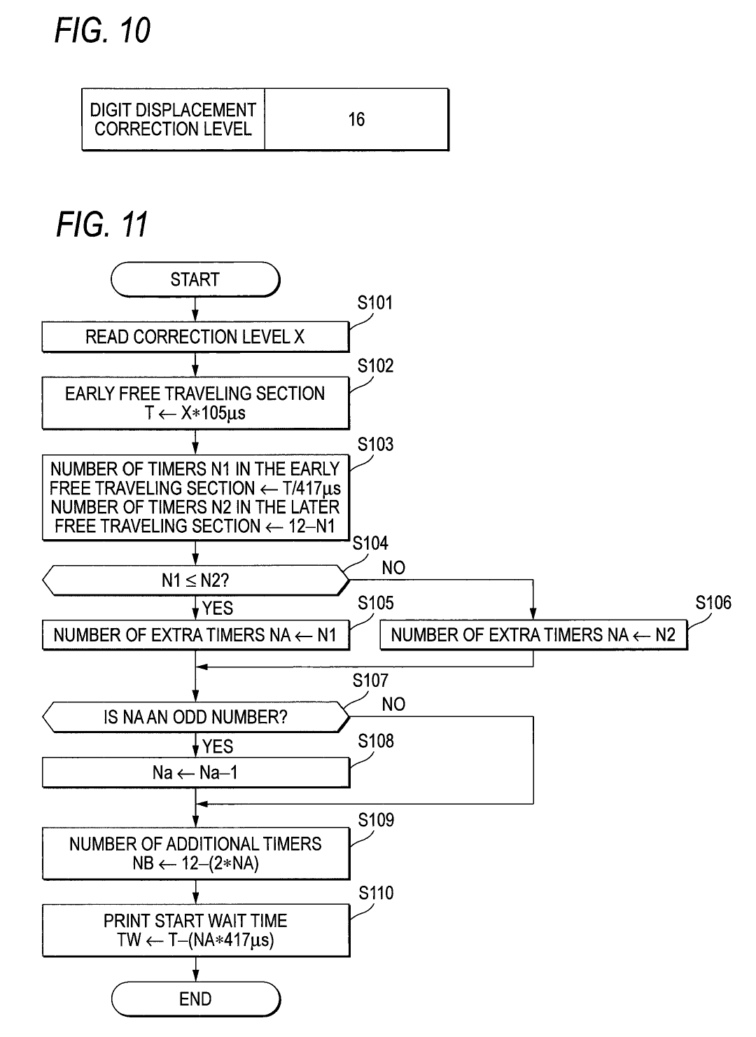

FIG. 10 shows an example of misalignment correction level stored into a storage 12. An integer value in the range of 0 to 51 is set to the misalignment correction level stored into the storage 12. The misalignment correction level stored in the storage 12 is updated when predetermined command data to instruct update of a misalignment correction level is received from a host computer via an interface 13 or when a predetermined operation is made by the user to instruct update of a misalignment correction level by using an operation panel (not shown) on the printer 10.

In case the misalignment correction level is 24, the time period from the start timing of a constant speed section to the first print timing is 2520 μs (=24*105 μs) and the time period from the first print timing to the end timing of the constant speed section is 2484 μs (=12*417 μs−2520 μs) and both time periods are almost equal to each other. That is, the relationship between the misalignment correction level and each print timing on the going path and returning path is as shown in FIG. 2 or FIG. 15. Each print timing in this state is called reference print timing. In case the misalignment correction value is 0 to 23, the print timing is corrected to be earlier than the reference print timing. In such a case, as the value of the misalignment correction level becomes smaller, the time difference between the print timing and the reference print timing increases. In case the misalignment correction value is 25 to 51, the print timing is corrected to be later than the reference print timing. In such a case, as the value of the misalignment correction level becomes larger, the time difference between the print timing and the reference print timing increases. Thus, the misalignment correction level is information indicating how much time the print timing is to be advanced or delayed with respect to the reference print timing.

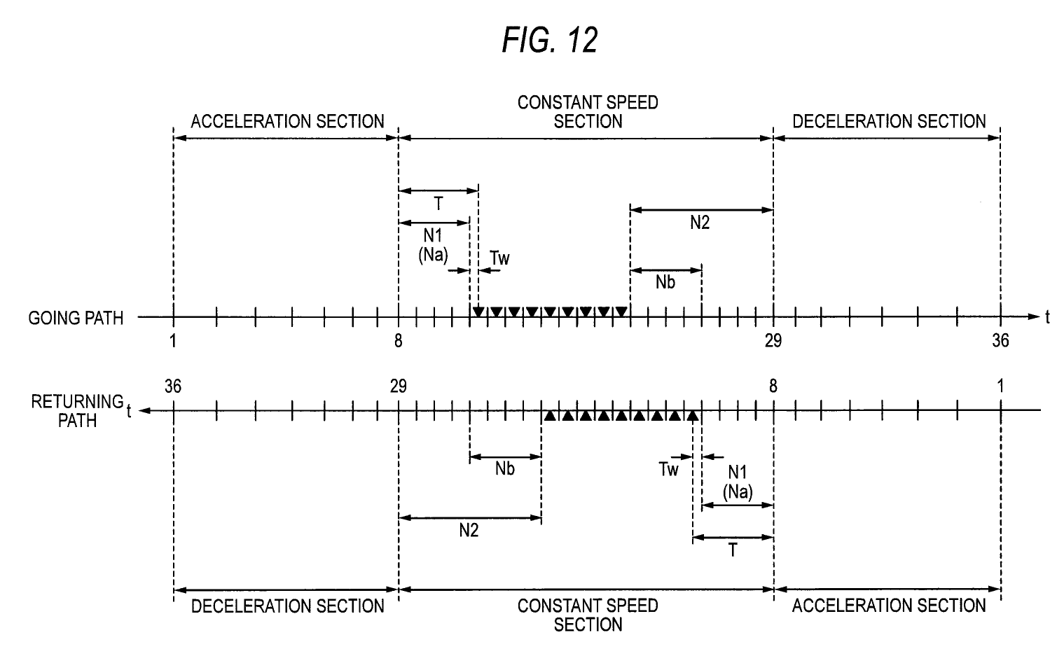

Processing in the printer 10 will be described. FIG. 11 is a flowchart mainly showing processing executed by the printer 10 related to the invention. Processing shown in FIG. 11 is executed for example in case the printer 10 is powered on or the correction level stored in the storage 12 is updated. The processing shown in FIG. 11 is performed when a program read from the storage 12 is executed by the controller 11. FIG. 12 illustrates the details of processing shown in FIG. 11. FIG. 12 shows driving control of a carriage motor and a print head made while the carriage is reciprocating, same as FIGS. 15 to 17.

As shown in FIG. 11, the printer 10 reads a correction level X (S101) The printer 10 calculates an early free traveling section T (S102). The early free traveling section T is the time length of an early free traveling section assumed in case the largest number of timers (12 timers in this embodiment) are added in a constant speed section (refer to FIG. 12). The early free traveling section is calculated using Expression (1). A multiplying operator is herein represented as “*”.

T=X*105 μs (1)

Then, the printer 10 calculates the number of timers N1 in the early free traveling section and the number of timers N2 in the late free traveling section (S103). The number of timers N1 in the early free traveling section is the number of timers corresponding to an early free traveling time T1. The number of timers N2 in the later free traveling section is the number of timers assumed corresponding to the late free traveling section assumed in case the largest number of timers are added in the constant speed section (refer to FIG. 12). The number of timers N1 in the early free traveling section and the number of timers N2 in the later free traveling section are calculated using Expressions (2) or (3). In Expression (3), “12” indicates the maximum number of timers to be added in the constant speed section. The fractional portion of the number of timers N1 in the early free traveling section is dropped and the resulting number of timers N1 in the early free traveling section and the number of timers N2 in the later free traveling section are integers.

N1=T1/417 μs (2)

N2=12−N1 (3)

The printer 10 determines whether the number of timers N1 in the early free traveling section is equal to or smaller than the number of timers N2 in the later free traveling section (S104). The number of timers N1 in the early free traveling section is equal to or smaller than the number of timers N2 in the later free traveling section in case the number of timers N1 in the early free traveling section is 6 or less, so that as an alternative it may be determined whether the number of timers N1 in the early free traveling section is 6 or less in step S104. In case the number of timers N1 in the early free traveling section is equal to or smaller than the number of timers N2 in the later free traveling section, the number of timers N1 in the early free traveling section is set to the number of extra timers Na (S105). In case the number of timers N1 in the early free traveling section is larger than the number of timers N2 in the later free traveling section, the number of timers N2 in the later free traveling section is set to the number of extra timers Na (S106). FIG. 12 shows a case where the number of timers N1 in the early free traveling section is set to the number of extra timers Na.

When the number of timers N1 in the early free traveling section or number of timers N2 in the later free traveling section is set to the number of extra timers Na, the printer 10 determines whether the number of extra timers Na is an odd number (S107). In case the number of extra timers Na is an odd number, the printer 10 subtracts 1 from the number of extra timers Na to make the number of extra timers Na an even number (S108). The number of extra timers Na is made an even number so that half the number of additional timers Nb described later will be always an even number. Its reason will be described later.

The printer 10 then calculates the number of additional timers Nb (S109). The number of additional timers Nb is calculated using Expression (4). In Expression (4), “12” indicates the maximum number of timers to be added in the constant speed section.

Nb=12−(2*Na) (4)

Then the printer 10 calculates a print start wait time Tw (S110). The print start wait time Tw is calculated using Expression (5).

Tw=T−(Na*417 μs) (5)

The number of additional timers Nb and the print start wait time Tw are stored into the storage 12 and used for print control such as carriage shift control or print head driving control.

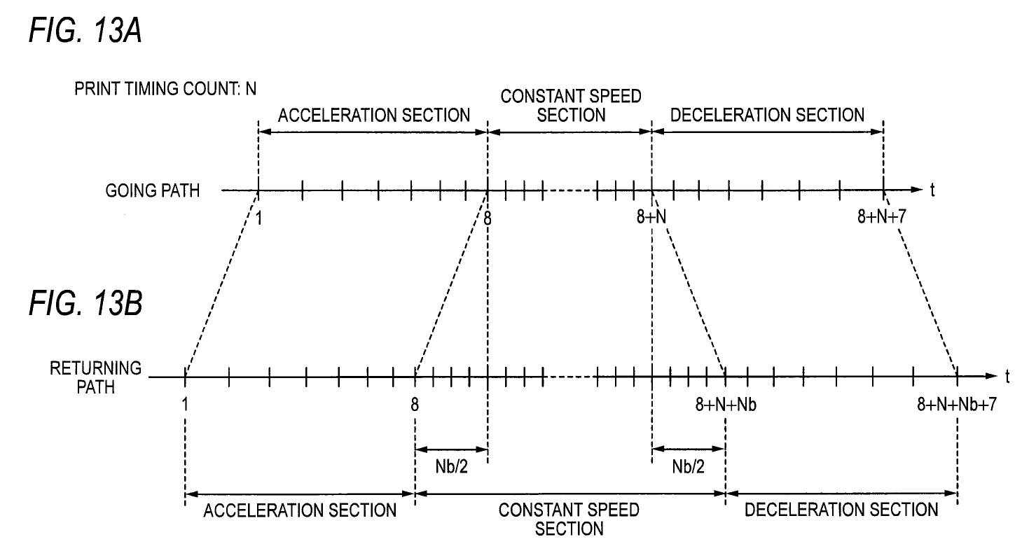

FIGS. 13A and 13B illustrate how the number of additional timers Nb is used in print control. FIG. 13A show an acceleration section, a constant speed section and a deceleration section assumed in case the number of timers in the constant speed section is equal to the number of print timings, that is, in case the number of timers in the constant speed section is the smallest. FIG. 13B shows an acceleration section, a constant speed section and a deceleration section assumed when actual printing is performed. FIGS. 13A and 13B show a case where the N print timings are set.

As shown in FIG. 13B when actual printing is performed, timers as many as half the number of additional timers Nb are respectively added at both ends of the constant speed section. In this case, the drive timings of the carriage motor 15 as many as half the number of additional timers Nb are respectively added at both ends of the constant speed section. That is, the step count of the carriage motor 15 in the constant speed section (step count to cause the carriage to travel in the constant speed section) increases by the number of additional timers Nb. Thus, the number of additional timers Nb is also information that indicates an increased step count (additional step count) of the carriage motor 15 in a constant speed section. While FIGS. 13A and 13B show the process on the going path alone, the same applies to the returning path as well.

An acceleration section, a constant speed section and a deceleration section assumed in case the misalignment correction level is 0 to 7 are shown in FIG. 5 as an example. In case the misalignment correction level is 0 to 7, the number of additional timers Nb is 12. Thus, six timers are respectively added at both ends of the constant speed section as shown in FIG. 5 and the total number of timers in the constant speed section is 21.

An acceleration section, a constant speed section and a deceleration section assumed in case the misalignment correction level is 8 to 15 are shown in FIG. 4 as an example. In case the misalignment correction level is 8 to 15, the number of additional timers Nb is 8. Thus, four timers are respectively added at both ends of the constant speed section as shown in FIG. 4 and the total number of timers in the constant speed section is 17. In this case, the number of extra timers Na is 2 so that two timers are respectively removed from both ends of the constant speed section compared with a case (refer to FIG. 5) where the number of timers in the constant speed section is largest.

An acceleration section, a constant speed section and a deceleration section assumed in case the misalignment correction level is 16 to 23 are shown in FIG. 3 as an example. In case the misalignment correction level is 16 to 23, the number of additional timers Nb is 4. Thus, two timers are respectively added at both ends of the constant speed section as shown in FIG. 3 and the total number of timers in the constant speed section is 13. In this case, the number of extra timers Na is 4 so that four timers are respectively removed from both ends of the constant speed section compared with a case (refer to FIG. 5) where the number of timers in the constant speed section is largest.

An acceleration section, a constant speed section and a deceleration section assumed in case the misalignment correction level is 24 to 27 are shown in FIG. 2 as an example. In case the misalignment correction level is 24 to 27, the number of additional timers Nb is 0. Thus, the number of timers in the constant speed section is equal to the print timing count as shown in FIG. 2.

An acceleration section, a constant speed section and a deceleration section assumed in case the misalignment correction level is 28 to 35 are shown in FIG. 6 as an example. In case the misalignment correction level is 28 to 35, the number of additional timers Nb is 4. Thus, two timers are respectively added at both ends of the constant speed section as shown in FIG. 6 and the total number of timers in the constant speed section is 13. In this case, the number of extra timers Na is 4 so that four timers are respectively removed from both ends of the constant speed section compared with a case (refer to FIG. 8) where the number of timers in the constant speed section is largest.

An acceleration section, a constant speed section and a deceleration section assumed in case the misalignment correction level is 36 to 43 are shown in FIG. 7 as an example. In case the misalignment correction level is 36 to 43, the number of additional timers Nb is 8. Thus, four timers are respectively added at both ends of the constant speed section as shown in FIG. 7 and the total number of timers in the constant speed section is 17. In this case, the number of extra timers Na is 2 so that two timers are respectively removed from both ends of the constant speed section compared with a case (refer to FIG. 8) where the number of timers in the constant speed section is largest.

An acceleration section, a constant speed section and a deceleration section assumed in case the misalignment correction level is 44 to 51 are shown in FIG. 8 as an example. In case the misalignment correction level is 44 to 51, the number of additional timers Nb is 12. Thus, six timers are respectively added at both ends of the constant speed section as shown in FIG. 8 and the total number of timers in the constant speed section is 21.

In case the carriage motor 15 is a stepping motor of the 1-2 phase excitation system, it is necessary to set an even-number step count of the carriage motor 15 from start of travel of the carriage until it stops. This is because the phase of the carriage motor 15 should be single while the carriage is stopped. With this regard, the number of timers on the going path or returning path increases by the number of additional timers Nb in this embodiment. The number of additional timers Nb is always even (refer to Expression (4)) so that the step count of the carriage motor 15 on the going path or returning path does not change from an even number to an odd number. In this embodiment, the number of timers assumed in case the carriage travels from the centering position to the end of a reciprocating range at the start of printing increases by half the number of additional timers Nb. With the steps S107 and S108 in FIG. 11, half the number of additional timers Nb remains an even number so that the number of timers related to the travel does not change from an even number to an odd number.

The driving control of the print head 16 is executed based on the print start wait time Tw. The print start wait time Tw indicates the time from the start timing of the constant speed section to the first print timing. Thus, whether the first print timing is reached is determined by monitoring whether the print start wait time Tw has elapsed since the start timing of the constant speed section. Each print timing interval is a predetermined time interval (417 μs in this embodiment) so that whether a next print timing is reached is determined by monitoring whether a predetermined time has elapsed since the last print timing. When each print timing is reached, the print head 16 is driven based on the print data and printout on a recording medium takes place.

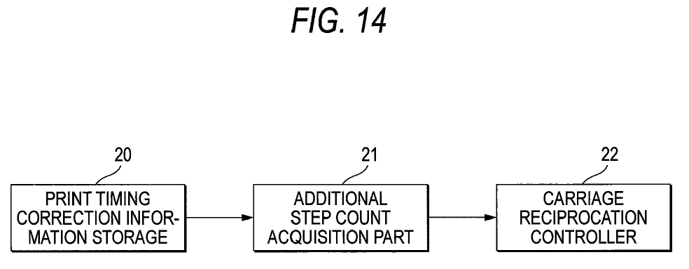

Next, features provided by the printer 10 will be described. FIG. 14 is a functional block diagram mainly showing the features related to the invention among those provided by the printer 10. As shown in FIG. 14, the printer 10 functionally includes a print timing correction information storage 20, an additional step count acquisition part 21, and a carriage reciprocation controller 22.

The print timing correction information storage 20 is implemented by the storage 12. The print timing correction information storage 20 stores the print timing correction information indicating the degree of correction of print timing. The print timing correction information is information indicating how much time the print timing is to be advanced or delayed. In this embodiment, the misalignment correction level is equivalent to “print timing correction information”.

The additional step count acquisition part 21 is mainly implemented by the controller 11 and the storage 12. The additional step count acquisition part 21 acquires, as an additional step count, the step count of the carriage motor 15 corresponding to the degree of correction of print timing indicated by the print timing correction information stored in the print timing correction information storage 20. The additional step count acquisition part 21 (additional step count information storage means) stores additional step count information including the degree of correction of print timing and additional step count associated with each other. The additional step count acquisition part 21 acquires the additional step count corresponding to the degree of correction of print timing indicated by the print timing correction information stored in the print timing correction information storage 20 based on the additional step count information.

The additional step count information may be one or more operational expressions used to calculate the additional step count based on the degree of correction of print timing. For example, the additional step count information may be a table where the degree of correction of print timing is associated with the additional step count. Or, the additional step count information may be a combination of one or more operational expressions and a table.

In this embodiment, the number of additional timers Nb is equivalent to “additional step count”. Expressions (1) to (4) are equivalent to “additional step count information”.

The carriage reciprocation controller 22 is mainly implemented by the controller 11. The carriage reciprocation controller 22 controls the step count of the carriage motor 15 related to reciprocation of the carriage based on the step count of the carriage motor 15 corresponding to the print timing count set on the going path or returning path as well as the additional step count acquired by the additional step count acquisition part 21. As the print area on the recording medium is identified based on the print data and the print timing count is set corresponding to the print area, the print timing count set to the going path or returning path is identified based on the print data.

As described above, on the printer 10, the number of timers on the going path and returning path of a carriage is not fixed to a maximum number of timers and variably controlled depending on the degree of correction of print timing. In other words, the step count of the carriage motor 15 related to reciprocation of the carriage is not fixed to a maximum number of timers. That is, the reciprocating range of the carriage is not fixed to a maximum reciprocating range. With the printer 10, it is possible to reduce the reciprocating range of the carriage thus shortening the time required for reciprocation of the carriage. As a result, with the printer 10, it is possible to perform misalignment correction while enhancing the throughput.

The printer 10 is capable of performing misalignment correction while enhancing the throughput both in case the print timing is advanced and in case the print timing is delayed.

On the printer 10, the misalignment correction level represents the time T shown in FIG. 9 in units of 105 μs so that the print timing may be adjusted in units of 105 μs. The misalignment correction level may represents the time T shown in FIG. 9 in units of a period shorter than 105 μs. This allows the print timing to be adjusted units of a period shorter than 105 μs.

The invention is not limited to the foregoing embodiments.

For example, a table including the misalignment correction level, the number of additional timers Nb and the print start wait time Tw associated with each other may be stored in the storage 12. In this case, the printer 10 may read the additional timers Nb and the print start wait time Tw corresponding to the updated misalignment correction level obtained in case the printer 10 is activated or the misalignment correction level stored in the storage 12 is updated. The printer 10 may execute print control based on the number of additional timers Nb and the print start wait time Tw.

For example, the printer 10 may perform printing in an acceleration section or a deceleration section also.

The invention is applicable to a serial printer such as a dot-impact printer, an inkjet printer or a thermal printer.

What is claimed is:

1. A printer, which performs printout on a recording medium on a going path and a returning path, comprising:
a carriage mounting a print head;
a stepping motor for causing the carriage to reciprocate with respect to the recording medium;
a print timing correction information storage unit for storing print timing correction information indicating a degree of correction of print timing;
an additional step count acquisition unit for acquiring a step count of the stepping motor corresponding to the degree of correction of print timing indicated by the print timing correction information as an additional step count; and
a carriage reciprocation control unit for controlling a step count of the stepping motor related to reciprocation of the carriage based on a step count of the stepping motor corresponding to a print timing count set to the going path or the returning path and the additional step count acquired by the additional step count acquisition unit.

2. The printer according to claim 1, wherein:
the going path and the returning path each includes: an acceleration section where the carriage is accelerated; a constant speed section where the carriage travels at a constant speed; and a deceleration section where the carriage is decelerated;
printout on the recording medium is made in the constant speed section; and
the carriage reciprocation control unit controls a step count of the stepping motor related to the constant speed section based on a step count of the stepping motor corresponding to a print timing count set to the constant speed section and the additional step count acquired by the additional step count acquisition unit.

3. The printer according to claim 1, wherein
the additional step count acquisition unit includes an additional step count information storage unit for storing additional step count information associating the degree of correction of the print timing and the additional step count, and the additional step count acquisition unit acquires the additional step count corresponding to the degree of correction of print timing indicated by the print timing correction information based on the additional step count information.

4. The printer according to claim 2, wherein
the additional step count acquisition unit includes an additional step count information storage unit for storing additional step count information associating the degree of correction of the print timing and the additional step count, and the additional step count acquisition unit acquires the additional step count corresponding to the degree of correction of print timing indicated by the print timing correction information based on the additional step count information.

5. A printer control method for controlling a printer including a carriage mounting a print head, a stepping motor for causing the carriage to reciprocate with respect to a recording medium and a print timing correction information storage unit for storing print timing correction information indicating a degree of correction of print timing, the printer performing printout on the recording medium on a going path and a returning path, the method comprising:
reading the print timing correction information indicating the degree of correction of print timing from the print timing correction information storage unit;
acquiring a step count of the stepping motor corresponding to the degree of correction of print timing indicated by the print timing correction information as an additional step count; and
controlling a step count of the stepping motor related to reciprocation of the carriage based on a step count of the stepping motor corresponding to a print timing count set to the going path or the returning path and the additional step count.
